(19) United States
(12) Patent Application Publication
(10) Pub. No.: US 2009/0138252 A1
(43) Pub. Date: May 28, 2009

(54) Method and system of evaluating disease severity

(75) Inventors: An-Tsan Tsai, Panchiao City (TW); Pin-Chuan Chen, Taichung City (TW); Kuan-Yu Chen, Chungho City (TW); Chih-Hao Hsu, Taipei City (TW)

Correspondence Address: Joe McKinney Muncy, PO Box 1364, Fairfax, VA, 22038-1364, US

(73) Assignee: Institute for Information Industry

(21) Appl. No.: 12/000,749

(22) Filed: Dec. 17, 2007

(30) Foreign Application Priority Data
Nov. 23, 2007 (TW) 96144635

(51) Int. Cl. G06G 7/48

(52) U.S. Cl. 703/11

(57) ABSTRACT

A method of evaluating disease severity is disclosed. The method uses physiological parameters and a historical database of diseases to determine a disease presented by the physiological parameters, to evaluate the disease severity and developing tendency, and to determine a suggested handling order when multiple diseases occur at the same time. The method provides a training stage and an executing stage. The training stage includes obtaining historical disease data from the historical database of diseases, and establishing a most-suited math model for the disease. The executing stage includes normalizing physiological parameters, calculating a strength value of the disease, and calculating a priority value based on the strength value of the disease and a probability value of the disease being selected in order to determine the suggested handling order. A system of evaluating disease severity is also disclosed therein.

### RELATED APPLICATIONS

This application claims priority to Taiwan Application Serial Number 96144635, filed Nov. 23, 2007, which is herein incorporated by reference.

### BACKGROUND

1. Field of Invention

The present invention relates to a method and system of evaluating severity. More particularly, the present invention relates to a method and system of evaluating disease severity.

2. Description of Related Art

We live in an information age with rapid development and fast changes. In many areas, computers have been used to assist in the diagnosis of a condition or an event in one form or another. The basis of the diagnosis mostly depends on the known conditions or events from the related field, especially in the medical field with physiological parameters involved.

In response to the coming of an aging society, patient monitoring has matured gradually. The major growing momentum in this field is that it is not limited by time or place to provide quality medical or health care. One of the monitoring functions available is to monitor patients' body conditions with the help of instruments and pre-established rule-bases. The physiological parameters are read from the instruments. When the parameters reach the alert values in the rule-base, an alarm is triggered so that the patient receives in time care.

However, there are disadvantages. Diseases determined by multiple physiological parameters couldn't be presented by such a monitoring function. So, doctors and nurses have to diagnose diseases with their professional experiences by themselves. Doctors and nurses with lots of experiences can diagnose a disease immediately, but junior doctors and nurses might not be able to respond promptly and appropriately. Besides, when the parameters change in values, the developing tendency and severity of the disease cannot be determined. Also, it offers no help when multiple diseases occur at the same time.

For the foregoing reasons, there is a need to improve the stated problem by a method and system of evaluating disease severity.

### SUMMARY

An objective of the present invention is to provide a method of evaluating disease severity.

Another objective of the present invention is to provide a system for evaluating disease severity.

To achieve the foregoing objectives, and in accordance with the purpose of the present invention as broadly described herein, the present invention uses physiological parameters and a historical database of diseases to determine a disease presented by the physiological parameters, to evaluate the disease severity and developing tendency, and to determine a suggested handling order when multiple diseases occur at the same time.

The method of evaluating disease severity provides a training stage and an executing stage. The training stage includes the following steps: obtaining historical disease data from the historical database of diseases, and establishing a most-suited math model for the disease. The executing stage includes the following steps: normalizing physiological parameters, calculating a strength value of the disease, and calculating a priority value based on the strength value of the disease and a probability value of the disease being selected in order to determine the suggested handling order.

The system for evaluating disease severity includes a disease model analyzer, a parameter normalizer, a disease severity evaluator, and a disease priority evaluator. The disease model analyzer establishes a most-suited math model for a disease with a training mode and historical disease data from a historical database of diseases. The parameter normalizer normalizes the physiological parameters to obtain normalized physiological parameters. The disease severity evaluator calculates a strength value of the disease by substituting the normalized physiological parameters into the most-suited math model, and analyzes the developing tendency of the disease. The disease priority evaluator calculates a priority value of the disease based on the strength value of the disease and a probability value of the disease being selected, and determines a suggested handling order based on the priority value of the disease when multiple diseases happen at the same time.

In conclusion, the invention determines a disease presented by the physiological parameters, evaluates the disease severity and developing tendency, and determines a suggested handling order when multiple diseases occur at the same time.

These and other features, aspects, and advantages of the present invention will become better understood with reference to the following description and appended claims.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a generalized flow chart of the method of evaluating disease severity according to one preferred embodiment of this invention;

FIG. 2 is a flow chart showing the steps of establishing a most-suited math model according to one preferred embodiment of this invention;

FIG. 3 is a diagram showing normalizing physiological parameters according to one preferred embodiment of this invention;

FIG. 4 is a diagram showing a most-suited math model according to one preferred embodiment of this invention; and

FIG. 5 is a generalized diagram showing the system for evaluating disease severity according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

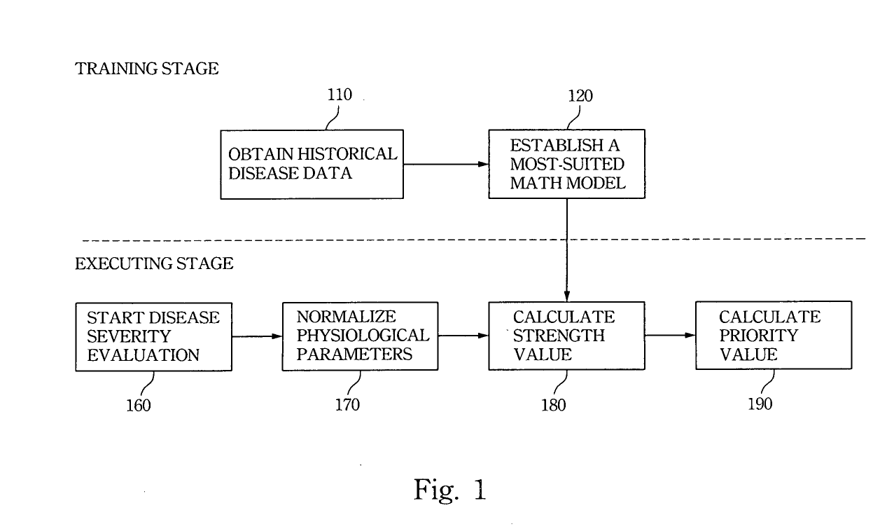

Reference is now made to FIG. 1, which is a generalized flow chart of the method of evaluating disease severity according to one preferred embodiment of this invention. The method of evaluating disease severity provides a training stage and an executing stage. The training stage includes step 110, obtaining historical disease data from a historical database of diseases, and step 120, establishing a most-suited math model for the disease. The executing stage includes step 160, starting disease severity evaluation, step 170, normalizing physiological parameters to obtain normalized physiological parameters, step 180, calculating a strength value of the disease by substituting the normalized physiological parameters into the most-suited math model, and step 190, calculating a priority value based on the strength value of the disease and a probability value of the disease being selected.

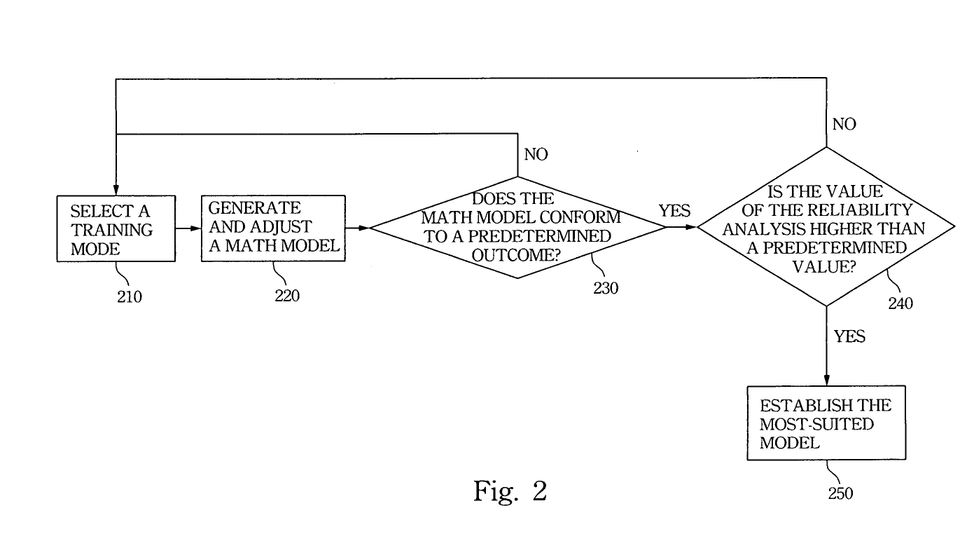

Reference is now made to FIG. 2, which is a flow chart showing the steps of establishing a most-suited math model according to one preferred embodiment of this invention. The steps of establishing a most-suited math model include the following: step 210, selecting a training mode, step 220, generating and adjusting a math model for the disease with the training mode, step 230, determining whether the math model conforms to a predetermined outcome, step 240, determining whether the value of the reliability analysis is higher than a predetermined value, and step 250, establishing the most-suited model for the disease when the value of the reliability analysis is higher than the predetermined value. At step 230, when the math model for the disease does not conform to the predetermined outcome, the flow goes back to step 210 and selects a new training mode. At step 240, when the value of the reliability analysis is lower than the predetermined value, the flow goes back to step 210 and selects a new training mode. The training mode can be a statistical method, a mathematical method, an artificial intelligence method, or other techniques with training abilities. Here, the training mode uses a regression analysis to analyze the relationship between the physiological parameters and the severity of the disease. When a disease can be determined with three physiological parameters X₁, X₂, and X₃, a disease severity function HP(CE)=αX₁+βX₂+γX₃ can demonstrate the relationship between the physiological parameters and the severity of the disease. If the severity of the disease from light to severe is represented as degree 1 to degree 3, coefficients α, β, and γ can be derived with large amount of physiological parameters from the historical database of diseases. Then, if the disease severity function HP conforms to the predetermined outcome, and if the value of the reliability analysis is higher than the predetermined value, the disease severity function HP is established as the most-suited model for the disease.

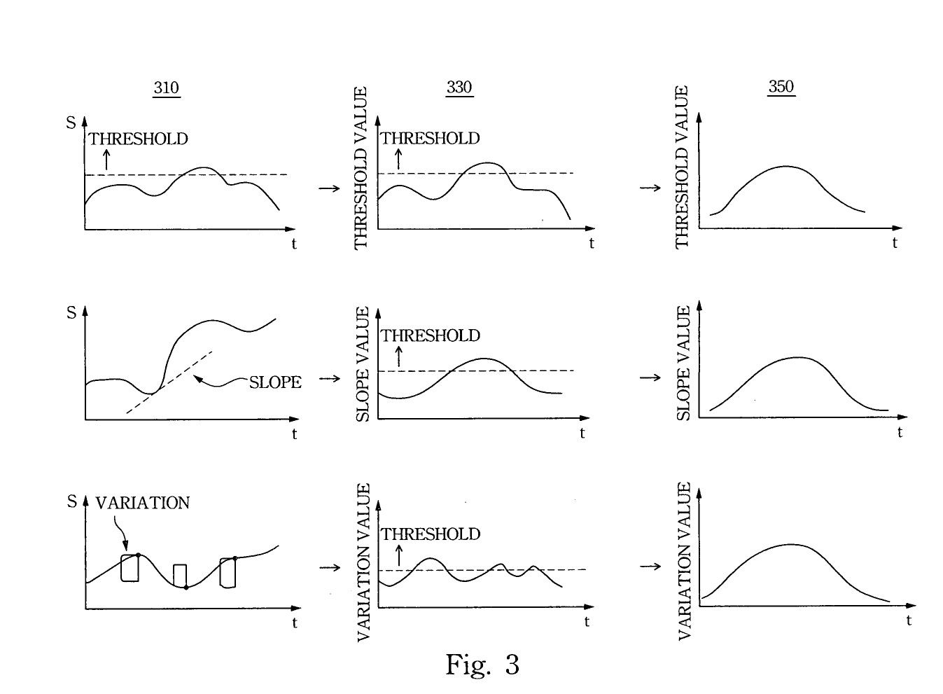

Reference is now made to FIG. 3, which is a diagram showing normalizing physiological parameters according to one preferred embodiment of this invention. The purpose of normalizing physiological parameters is to standardize different physiological parameters. The process is practiced with range transformation and normalization on an event strength evolution curve, which could be formed with an event detecting method based on event strength evolution, or with other kinds of event detecting methods. The event detecting method based on event strength evolution transforms the original value of a physiological event, which is the value measured from a medical monitor, into the strength value of the physiological event. By transforming the original value to the strength value, a false physiological event can be screened. Also, the start and finish of a physiological event can be detected. Besides, the severity and the developing tendency of a physiological event can be determined.

State 310 shows three different event strength evolution curves before normalizing physiological parameters. Each of the curves comes from a physiological event such as blood pressure or body temperature. Each physiological event takes a firing point rule and a nutrition growing function. The nutrition growing function depicts the strength changes of the physiological event along the timeline. The firing point rule determines when an event firing notice should be transmitted to a receiver. When the original value of a physiological event reaches or is higher than an alert value, it does not necessarily mean that a true physiological event happened. For example, a patient might accidentally press a wrong button. So, only when a physiological event is true or meaningful, an event firing notice should be transmitted. The firing point rule can be threshold, slope, variation, or other appropriate rules.

State 330 shows three different event strength evolution curves after range transformation of physiological parameters. At this moment, the firing point rules of the three physiological events are all converted to threshold. The values of the y-axis are threshold values, slope values, and variation values respectively. State 350 shows three different event strength evolution curves after normalizing physiological parameters. All of the values along the y-axis fall within 0 to 1.

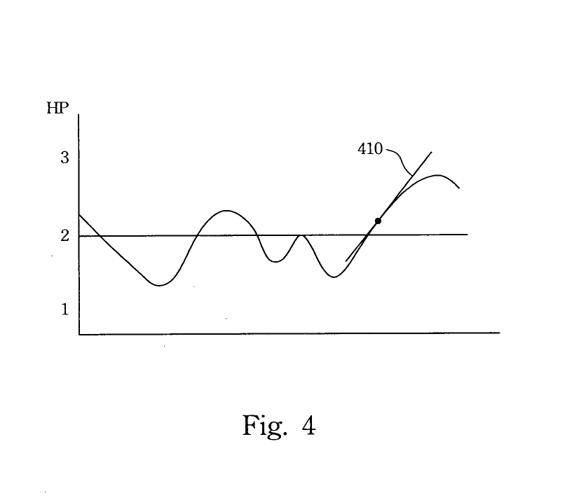

Reference is now made to FIG. 1 and FIG. 4. FIG. 4 is a diagram showing a most-suited math model according to one preferred embodiment of this invention. If the most-suited math model of a disease is the disease severity function HP(CE)=X₁+1.5X₂+X₃, and the severity of the disease, which is on the left side of the disease severity function, is represented as 1—light, 2—medium, and 3—severe. The strength value of the disease at that time can be calculated by substituting the normalized physiological parameters, obtained from step 170, into the disease severity function HP, obtained from step 120, to get a strength value between 2 and 3. The strength value of the disease evaluates the severity of the disease. Furthermore, the tangent at this point 410 can analyze the developing tendency of the disease at that time, which is getting more severe.

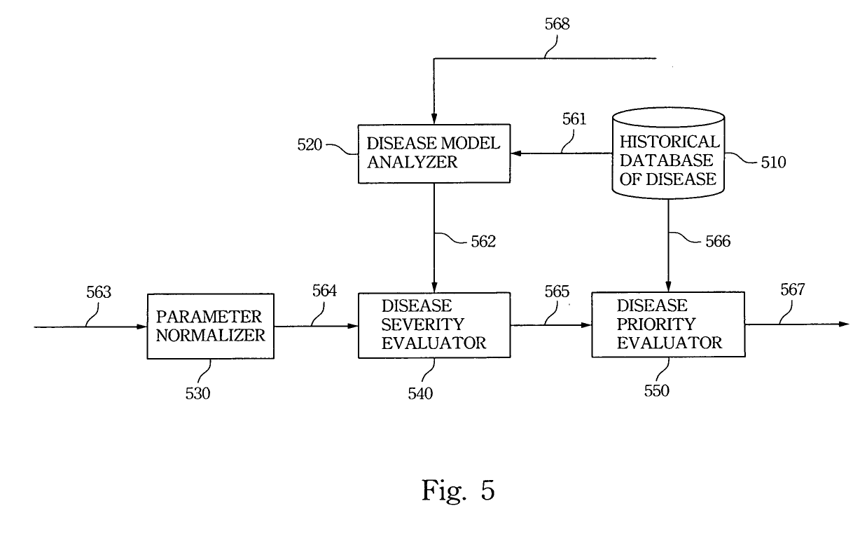

Reference is now made to FIG. 5, which is a generalized diagram showing the system for evaluating disease-severity according to one preferred embodiment of this invention. The system for evaluating disease severity includes a disease model analyzer 520, a parameter normalizer 530, a disease severity evaluator 540, and a disease priority evaluator 550.

The disease model analyzer 520 obtains historical disease data 561 from a historical database of diseases 510. The historical database of diseases 510 collects a great quantity of medical care records, cases, and information of different diseases, and opinions of experts from different medical fields. For example, the content of a medical care record might include the following. A patient's systolic pressure is lower than 80, and perspiration is higher than 30 times per minute. The doctor diagnoses the patient with Ketoacidosis with medium severity, and the care procedures taken at that moment. The disease model analyzer 520 establishes a most-suited math model 562 for a disease with historical disease data 561 obtained from a historical database of diseases 510. The most-suited math model 562 presents the relationship between physiological parameters and the disease. The physiological parameters are numbers such as the number of perspirations per minute, systolic pressure, and diastolic pressure. So, the disease model analyzer 520 analyzes historical disease data 561 to generate the most-suited math model 562, demonstrating the relationship between physiological parameters and the disease. When medical staff has feedback 568 to the most-suited math model 562, the disease model analyzer 520 practices a self-adapting mechanism, which appropriately adjusts the most-suited math model 562 based on the feedback 568.

The parameter normalizer 530 normalizes physiological parameters 563 to obtain normalized physiological parameters 564. The disease severity evaluator 540 calculates a strength value of the disease 565 by substituting the normalized physiological parameters 564 into the most-suited math model 562, and then, the strength value of the disease 565 evaluates the severity of the disease. Besides, the most-suited math model 562 analyzes the developing tendency of the disease. The disease priority evaluator 550 calculates a priority value of the disease 567 based on the strength value of the disease 565 and a probability value of the disease being selected 566, and, when multiple diseases happen at the same time, the disease priority evaluator 550 determines a suggested handling order based on the priority values of the multiple diseases.

The probability value of the disease being selected 566 is registered into the historical database of diseases 510 in advance. After the probability value of the disease being selected 566 is obtained from the historical database of diseases 510, a calculating method for the priority value of the disease 567 is taking the product of the strength value of the disease 565 and the probability value of the disease being selected 566 as the priority value of the disease 567. When multiple diseases happen at the same time, the disease with the highest priority value ranks first in the suggested handling order.

As embodied and broadly described herein, the embodiment determines a disease presented by the physiological parameters, evaluates the disease severity and developing tendency, and determines a suggested handling order when multiple diseases occur at the same time.

Although the present invention has been described in considerable detail with reference to certain preferred embodiments thereof, other embodiments are possible. Therefore, the spirit and scope of the appended claims should not be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of evaluating disease severity, using a plurality of physiological parameters and a historical database of diseases to determine a disease presented by the physiological parameters and evaluate severity of the disease, the method comprising:
providing a training stage, the training stage comprising:
(a) obtaining historical disease data from the historical database of diseases; and
(b) establishing a most-suited math model for the disease;
providing an executing stage, the executing stage comprising:
(c) normalizing the physiological parameters to obtain a plurality of normalized physiological parameters;
(d) calculating a strength value of the disease by substituting the normalized physiological parameters into the most-suited math model; and
(e) calculating a priority value of the disease based on the strength value of the disease and a probability value of the disease being selected.

2. The method of claim 1, wherein the historical database of diseases collects medical care records, cases, and information of different diseases, and opinions of experts from different medical fields.

3. The method of claim 1, wherein the priority value of the disease is a product of the strength value of the disease and the probability value of the disease being selected.

4. The method of claim 1, wherein step (d) further comprises analyzing the developing tendency of the disease.

5. The method of claim 1, wherein step (e) further comprises determining a suggested handling order based on the priority value of the disease when a plurality of diseases happen at the same time.

6. The method of claim 1, wherein step (b) comprises:
selecting a training mode;
generating and adjusting a math model for the disease with the training mode;
performing a reliability analysis when the math model conforms to a predetermined outcome; and
establishing the most-suited model for the disease when the value of the reliability analysis is higher than a predetermined value.

7. The method of claim 6, wherein step (b) further comprises selecting a new training mode when the math model for the disease does not conform to the predetermined outcome.

8. The method of claim 6, wherein step (b) further comprises selecting a new training model when the value of the reliability analysis is lower than the predetermined value.

9. The method of claim 6, wherein the training mode is a statistical method, a mathematical method, an artificial intelligence method, or other techniques with training abilities.

10. The method of claim 9, wherein the training mode uses a regression analysis to analyze relationship between the physiological parameters- and severity of the disease.

11. The method of claim 1, wherein step (c) is practiced with range transformation and normalization on an event strength evolution curve in order to standardize the physiological parameters, wherein the event strength evolution curve is formed with an event detecting method based on event strength evolution, or with other event detecting methods.

12. The method of claim 1, wherein step (b) further comprising providing a self-adapting mechanism when medical staff has a feedback to the most-suited math model of the disease, wherein the self-adapting mechanism appropriately adjusts the most-suited math model of the disease based on the feedback.

13. The method of claim 1, wherein the strength value of the disease is for evaluating severity of the disease.

14. A system for evaluating disease severity, the system comprising:
a disease model analyzer for establishing a most-suited math model for a disease with a training mode and historical disease data from a historical database of diseases;
a parameter normalizer for normalizing a plurality of physiological parameters to obtain a plurality of normalized physiological parameters;
a disease severity evaluator for calculating a strength value of the disease by substituting the normalized physiological parameters into the most-suited math model, and for analyzing the developing tendency of the disease; and
a disease priority evaluator for calculating a priority value of the disease based on the strength value of the disease and a probability value of the disease being selected, and for determining a suggested handling order when a plurality of diseases happen at the same time.

15. The system of claim 14, wherein the historical database of diseases collects medical care records, cases, and information of different diseases, and opinions of experts from different medical fields.

16. The system of claim 14, wherein the priority value of the disease is a product of the strength value of the disease and the probability value of the disease being selected.

17. The system of claim 14, wherein the training mode is a statistical method, a mathematical method, an artificial intelligence method, or other techniques with training abilities.

18. The system of claim 14, wherein the training mode uses a regression analysis to analyze relationship between the physiological parameters and severity of the disease.

19. The system of claim 14, wherein the parameter normalizer practices range transformation and normalization on an event strength evolution curve in order to standardize the physiological parameters, wherein the event strength evolution curve is formed with an event detecting method based on event strength evolution, or with other event detecting methods.

20. The system of claim 14, wherein the disease model analyzer practices a self-adapting mechanism when medical staff has a feedback to the most-suited math model of the disease, wherein the self-adapting mechanism appropriately adjusts the most-suited math model of the disease based on the feedback.

21. The system of claim 14, wherein the strength value of the disease is for evaluating severity of the disease.

22. A computer usable medium having stored thereon a computer readable program for causing a computer to evaluate disease severity, the program comprising:
providing a training stage, the training stage comprising:
(a) obtaining historical disease data from the historical database of diseases; and
(b) establishing a most-suited math model for the disease;
providing an executing stage, the executing stage comprising:
(c) normalizing the physiological parameters to obtain a plurality of normalized physiological parameters;
(d) calculating a strength value of the disease by substituting the normalized physiological parameters into the most-suited math model; and
(e) calculating a priority value of the disease based on the strength value of the disease and a probability value of the disease being selected.

23. The medium of claim 22, wherein the historical database of diseases collects medical care records, cases, and information of different diseases, and opinions of experts from different medical fields.

24. The medium of claim 22, wherein the priority value of the disease is a product of the strength value of the disease and the probability value of the disease being selected.

25. The medium of claim 22, wherein step (d) further comprises analyzing the developing tendency of the disease.

26. The medium of claim 22, wherein step (e) further comprises determining a suggested handling order based on the priority value of the disease when a plurality of diseases happen at the same time.

27. The medium of claim 22, wherein step (b) comprises:
selecting a training mode;
generating and adjusting a math model for the disease with the training mode;
performing a reliability analysis when the math model conforms to a predetermined outcome; and
establishing the most-suited model for the disease when the value of the reliability analysis is higher than a predetermined value.

28. The medium of claim 27, wherein step (b) further comprises selecting a new training mode when the math model for the disease does not conform to the predetermined outcome.

29. The medium of claim 27, wherein step (b) further comprises selecting a new training model when the value of the reliability analysis is lower than the predetermined value.

30. The medium of claim 27, wherein the training mode is a statistical method, a mathematical method, an artificial intelligence method, or other techniques with training abilities.

31. The medium of claim 30, wherein the training mode uses a regression analysis to analyze relationship between the physiological parameters and severity of the disease.

32. The medium of claim 22, wherein step (c) is practiced with range transformation and normalization on an event strength evolution curve in order to standardize the physiological parameters, wherein the event strength evolution curve is formed with an event detecting method based on event strength evolution, or with other event detecting methods.

33. The medium of claim 22, wherein step (b) further comprising providing a self-adapting mechanism when medical staff has a feedback to the most-suited math model of the disease, wherein the self-adapting mechanism appropriately adjusts the most-suited math model of the disease based on the feedback.

34. The medium of claim 22, wherein the strength value of the disease is for evaluating severity of the disease.
